(19) United States
(12) Patent Application Publication
(10) Pub. No.: US 2026/0132664 A1
(43) Pub. Date: May 14, 2026

(54) HINGE STRUCTURE FOR COACH DOOR

(71) Applicants: Kia Corporation, Seoul (KR); Hyundai Motor Company, Seoul (KR)

(72) Inventors: Zuobin Li, Shandong (CN); Hai Liang Wang, Shandong (CN)

(21) Appl. No.: 19/361,761

(22) Filed: Oct. 17, 2025

(30) Foreign Application Priority Data
Nov. 8, 2024 (CN) 202411590067.5

(51) Int. Cl. E05F 15/614

(52) U.S. Cl. CPC E05F 15/614; E05Y 2900/531

(57) ABSTRACT

A hinge structure for a vehicle coach door can include a bracket configured to be fixed to a vehicle body, wherein a first end portion of the bracket is hingedly coupled to a connecting plate, and a second end portion of the bracket includes an arch-shaped guide arm, a driving assembly coupled to the connecting plate to be movable along the guide arm, an electric-powered assembly coupled to the driving assembly, and a hinge arm configured to be fixed to the door, wherein the hinge arm is coupled to the electric-powered assembly so as to be movable relative to the electric-powered assembly, wherein the hinge arm is configured to be move linearly relative to the electric-powered assembly during a first operation, and wherein the hinge arm is configured to pivot in an arch shape relative to the bracket during a second operation.

### CROSS-REFERENCE TO RELATED APPLICATION

This application claims priority to and the benefit of Chinese Patent Application No. 202411590067.5 filed with the Chinese National Intellectual Property Administration on November 8, 2024, the entire contents of which are incorporated herein by reference.

### TECHNICAL FIELD

The present disclosure relates to a vehicle, and more particularly, to a hinge structure for a vehicle coach door.

### BACKGROUND

Vehicles are an indispensable means of transportation in modern life. Currently, the opening and closing methods of the doors on one side of small and medium-sized passenger vehicles are generally categorized into two types: a conventional front-hinged door configuration or a coach door configuration. Compared to vehicles using a conventional front-hinged door configuration, the two coach doors on one side of a vehicle open to both sides, providing a wide door opening space, thereby improving the convenience of passengers getting on and off the vehicle.

However, in vehicles using conventional coach doors, a design is generally used in which the front door presses against the rear door to prevent the front door from being caught in the rear door in the event of a side collision, making it difficult to open the front door. Accordingly, when opening a door, the front door must be opened first, followed by the rear door, and the rear door cannot be opened independently. In particular, even when only the rear seat passengers need to get in or out, the front door must still be opened first, which not only increases the inconvenience of opening and closing the door, but also easily gives the front seat passengers a bad riding experience.

The above information disclosed in this Background section is only for enhancement of understanding of the background of the present disclosure, and therefore it may contain information that does not form the prior art that is already publicly known, available, or in use.

### SUMMARY

Example embodiments of the present disclosure can provide a hinge structure for a coach door that is capable of realizing the independent opening and/or closing of a front door and/or a rear door, thereby improving the convenience of door opening and closing and enhancing the riding experience of an occupant.

A first embodiment of the present disclosure can provide a hinge structure for a coach door. The hinge structure for the coach door can include: a fixed bracket fixed to a vehicle body, wherein one end portion of the fixed bracket is hinged to a connecting plate, and the other end portion of the fixed bracket is provided with an arch-shaped guide arm; a driving assembly connected to the connecting plate to be movable along the guide arm; an electric-powered assembly connected to the driving assembly and capable of performing a first operation and a second operation by driving the driving assembly; and a hinge arm fixed to a door and connected to the electric-powered assembly so as to be relatively movable, wherein when the electric-powered assembly performs the first operation, the hinge arm linearly moves to linearly move the door, and when the electric-powered assembly performs the second operation, the hinge arm moves in an arch shape to rotate a door.

The driving assembly may include: a motor provided with an output shaft penetrating a first through-hole formed in the connecting plate; a first driving gear provided with teeth in a first predetermined arc region and fixed to the output shaft; and a second driving gear provided with teeth in a second predetermined arc region, fixed to the output shaft, and configured to roll along the guide arm to move the driving assembly along the guide arm.

The electric-powered assembly may include: an electric-powered plate having a second through-hole formed in a lower portion thereof and positioned between the first driving gear and the second driving gear, wherein the output shaft penetrates the second through-hole; and an electric-powered gear rotatably installed on the electric-powered plate and capable of engaging with the first driving gear, wherein a sliding pin is installed at a position close to an edge of the electric-powered gear.

One end portion of the hinge arm may be fixed to a door, a sliding groove extended along a width direction may be formed in a middle portion of the hinge arm, and the sliding pin may be inserted into the sliding groove and, when the electric-powered gear rotates, the sliding pin may slide along the sliding groove to cause the hinge arm to move along a length direction.

Guide teeth may be installed on the guide arm, and the second driving gear may be able to engage with the guide teeth.

When the first driving gear and the electric-powered gear are engaged, the second driving gear may not be engaged with the guide teeth, and when the first driving gear rotates by a first predetermined angle, the first driving gear may not be engaged with the electric-powered gear and the second driving gear may begin to be engaged with the guide gear.

The electric-powered plate may include: a main body; a curved portion connected to the main body and curved in a direction of the electric-powered gear, wherein the curved portion has a strip-shaped hole formed therein; and an extension portion extending from the curved portion in a direction away from the main body, wherein a guide bump guiding a hinge arm is installed on a back surface of the extension portion, wherein the other end portion of the hinge arm may penetrate the strip-shaped hole to be positioned between the guide bumps.

A shaft hole may be formed in the center of the electric-powered gear, and a shaft that is inserted into the shaft hole may be fixed to an upper portion of the main body.

A bushing and a sleeve may be installed on the shaft, the bushing may be positioned between an inner wall of the shaft hole and an outer wall of the shaft, and the sleeve may be positioned between the electric-powered gear and the electric-powered plate.

A base plate may be installed on the fixed bracket, a protruding plate may be provided at one end portion of the base plate, the connecting plate may be hinged to the protruding plate, and the guide arm may be provided at the other end portion of the base plate, and the guide arm may be bent in a direction of the connecting plate.

A second embodiment of the present disclosure can provide a vehicle including the hinge structure for the coach door according to the first embodiment of the present disclosure.

According to an embodiment of the present disclosure, independent opening and/or closing of the front door and/or the rear door may be implemented, thereby making it convenient to open and close the doors and improving the passenger's riding experience.

Advantages that may be obtained or expected from an embodiment of the present disclosure can be directly or implicitly disclosed in the detailed description of the present disclosure. That is, various advantages expected from the example embodiments of the present disclosure will be described in the following detailed description.

### BRIEF DESCRIPTION OF THE DRAWINGS

FIG. 1 is a schematic view of a hinge structure for a coach door according to an embodiment of the present disclosure.

FIG. 2 is a schematic view of a hinge structure for a coach door according to another embodiment of the present disclosure.

FIG. 3 is a schematic view of a fixed bracket of a hinge structure for a coach door according to an embodiment of the present disclosure.

FIG. 4 is a schematic view showing a portion of a hinge structure for a coach door according to an embodiment of the present disclosure.

FIG. 5 is an exploded view of FIG. 4.

FIG. 6 is a cross-sectional view taken along line A-A of FIG. 4.

FIG. 7 is a schematic view of a hinge arm of a hinge structure for a coach door according to an embodiment of the present disclosure.

FIG. 8A to FIG. 8C are schematic views illustrating an operation process of a hinge structure for a coach door according to an embodiment of the present disclosure when an electric assembly performs a first operation.

FIG. 9A to FIG. 9C are schematic views illustrating an operation process of a hinge structure for a coach door according to an embodiment of the present disclosure when an electric assembly performs a second operation.

It can be understood that the drawings simply illustrate features in order to explain some basic principles of example embodiments of the present disclosure, and are not necessarily drawn to scale. Specific design features disclosed in an example embodiment of the present disclosure (including, for example, specific sizes, directions, positions, and shapes) can be specifically determined in part according to applications and environments in which an embodiment of the present disclosure will be used.

Same reference numbers throughout a plurality of drawings can indicate same or equivalent parts of example embodiments of the present disclosure.

### DETAILED DESCRIPTION OF ILLUSTRATIVE EMBODIMENTS

Hereinafter, with reference to various example embodiments of the present disclosure in detail, these example embodiments will be described below with reference to the drawings. Although the present disclosure has been described in conjunction with example embodiments of the present disclosure, it can be understood that the present specification is not intended to necessarily limit the present disclosure to these example embodiments of the present disclosure. To the contrary, the present disclosure not only includes these example embodiments of the present disclosure, but also includes various alternatives, modifications, equivalents, and other embodiments within the scopes of the spirit of the present disclosure, the appended claims, and equivalents thereof.

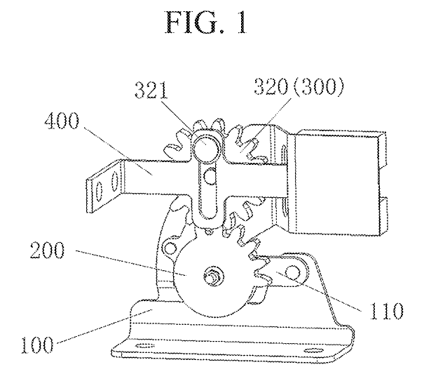

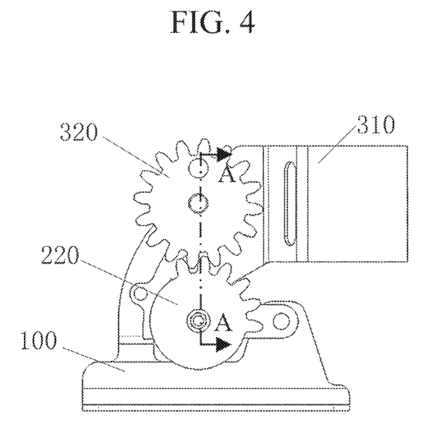

Hereinafter, with reference to FIG. 1 to FIG. 9C, a hinge structure for a coach door according to an embodiment of the present disclosure will be described.

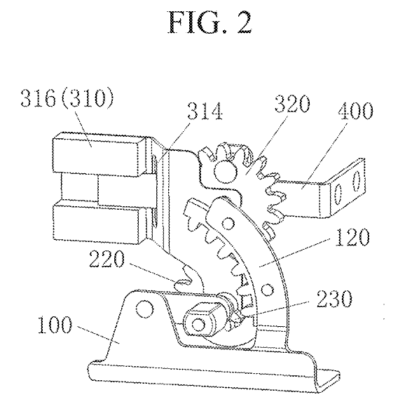

FIG. 1 is a schematic view of a hinge structure for a coach door according to an embodiment of the present disclosure. FIG. 2 is a schematic view of a hinge structure for a coach door according to an embodiment of the present disclosure. Specifically, FIG. 2 is a schematic view of the hinge structure for a coach door of FIG. 1 observed from a different direction.

As shown in FIG. 1 and FIG. 2, the hinge structure for the coach door according to an embodiment of the present disclosure can include a fixed bracket 100, a driving assembly 200, an electric-powered assembly 300, and a hinge arm 400.

The fixed bracket 100 can be fixed to a main body of a vehicle. A connecting plate 110 can be hingedly connected to one end portion of the fixed bracket 100, and an arch-shaped guide arm 120 can be provided to the other end portion of the fixed bracket 100. The driving assembly 200 can be connected to the connecting plate 110 and can be movable along the guide arm 120. The electric-powered assembly 300 can be connected to the driving assembly 200 and may perform a first operation and/or a second operation by an operation of the driving assembly 200. The hinge arm 400 can be fixed to a door and can be connected to the electric-powered assembly 300 in a relatively movable manner. When the first operation is performed through the electric-powered assembly 300, the hinge arm 400 can move in a straight line, thereby causing the door to move in a straight line. When the second operation is performed through the electric-powered assembly 300, the hinge arm 400 can move in an arch shape, thereby causing the door to rotate.

A hinge structure for a coach door according to an embodiment of the present disclosure may be applied to a rear door of a vehicle. When the hinge structure for the coach door according to an embodiment of the present disclosure is applied to a rear door of a vehicle, the fixed bracket 100 may be fixed to a vehicle body corresponding to the rear door, and the hinge arm 400 may be fixed to the rear door. In a case in which a rear seat occupant needs to get in or out, the first operation can be performed through the electric-powered assembly 300 to move the hinge arm 400 in a straight line to the rear (towards the rear of the vehicle), thereby moving the rear door in a straight line to the rear so that the front door and the rear door do not overlap and intersect each other. Thereafter, the second operation can be performed through the electric-powered assembly 300, causing the hinge arm 400 to move in an arch shape (rotate in a direction in which the rear door opens), whereby the rear door rotates to an opened state. In this manner, in a vehicle using coach doors, when only a rear seat occupant needs to get in or out, the rear door may be opened independently without first opening the front door, and after the rear seat occupant gets in or out, the rear door may be closed independently, which can make it convenient to open and close the door and improve the occupant's experience of getting in and out.

Optionally, a hinge structure for a coach door according to an embodiment of the present disclosure may be applied to a front door of a vehicle or simultaneously applied to both a front door and a rear door of a vehicle to improve the convenience of door opening and closing.

Hereinafter, with reference to FIG. 1 to FIG. 9C, a hinge structure for a coach door according to an embodiment of the present disclosure will be described, taking as an example a case in which the hinge structure for the coach door according to an embodiment of the present disclosure is applied to a rear door of a vehicle.

In an embodiment of the present disclosure, as shown in FIG. 1 to FIG. 3, a fixed bracket 100 can be provided with a base plate 130, and two first mounting holes 132 can be formed in the base plate 130. By inserting a fastening member such as a bolt into the first mounting hole 132, the fixed bracket 100 may be fixed to a vehicle body corresponding to the rear door of the vehicle. One end portion of the base plate 130 can be provided with a protruding plate 131, and a connecting plate 110 can be hingedly coupled to the protruding plate 131. The other end portion of the base plate 130 can be provided with an arch-shaped guide arm 120, which can be bent in the direction of the connecting plate 110. Specifically, the connecting plate 110 can be provided as a long strip-shaped plate, and a hinge shaft 112 can be mountable at one end portion of the connecting plate 110. The connecting plate 110 can be hingedly coupled to the protruding plate 131 via the hinge shaft 112, and a first through-hole 111 can be formed at the other end portion of the connecting plate 110.

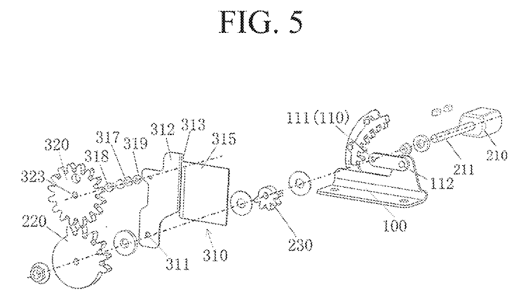

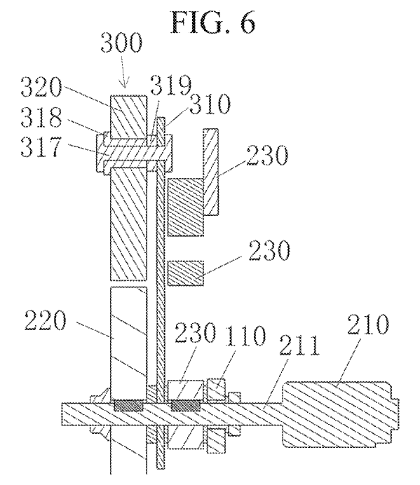

According to an embodiment of the present disclosure, as illustrated in FIG. 5 and FIG. 6, the driving assembly 200 can include a motor 210, a first driving gear 220, and a second driving gear 230. The motor 210 may be electrically connected to a vehicle's control system, and the operation of the motor 210 can be controlled through a button provided corresponding to the motor 210. The motor 210 can include an output shaft 211, and the output shaft 211 can pass through the first through-hole 111 of the connecting plate 110 to connect the motor 210 to the connecting plate 110. The output shaft 211 may rotate within the first through-hole 111. The first driving gear 220 and the second driving gear 230 can be each fixed to the output shaft 211. Specifically, in an embodiment of the present disclosure, the first driving gear 220 and the second driving gear 230 are each fixed to the output shaft 211 in a key-coupling manner. The first driving gear 220 can include teeth on a first predetermined arc region. The second driving gear 230 can include teeth on a second predetermined arc region.

According to an embodiment of the present disclosure, as illustrated in FIG. 5 and FIG. 6, the electric-powered assembly 300 can include an electric-powered plate 310 and an electric-powered gear 320. A second through-hole 311 can be formed in a lower portion of the electric-powered plate 310. The output shaft 211 can pass through the second through-hole 311 to connect the electric-powered plate 310 to the output shaft 211. The electric-powered plate 310 can be positioned between the first driving gear 220 and the second driving gear 230. The output shaft 211 may rotate within the second through-hole 311. The electric-powered gear 320 can be rotatably installed on the electric-powered plate 310, and a sliding pin 321 can be installed at a location close to an edge thereof. The first driving gear 220 can be engaged with the teeth of the electric-powered gear 320, such that the electric-powered gear 320 may rotate according to the rotation of the first driving gear 220.

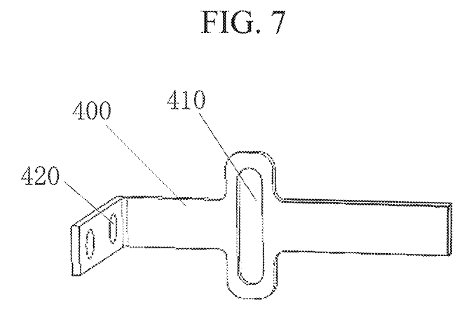

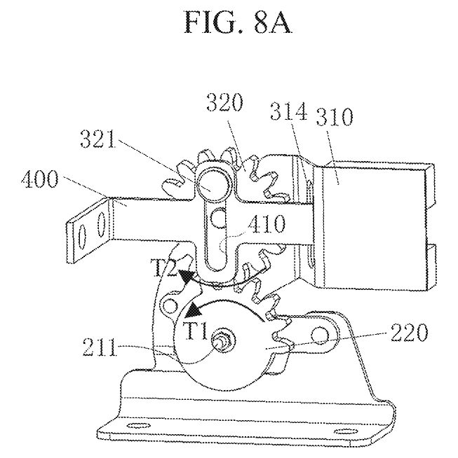

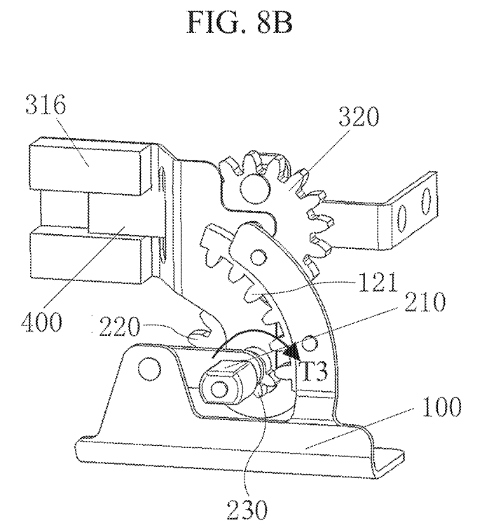

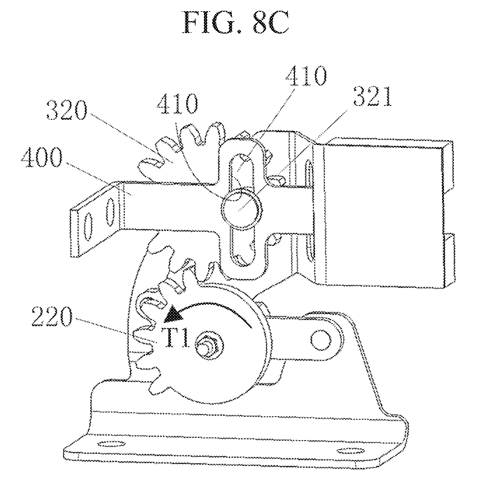

According to an embodiment of the present disclosure, as illustrated in FIG. 7 to FIG. 8C, two second mounting holes 420 can be formed at one end of the hinge arm 400, and the hinge arm 400 may be fixed to a vehicle rear door by inserting fastening members, such as bolts, into the second mounting holes. A sliding groove 410, which can be extended along a width direction, can be formed in a middle portion of the hinge arm 400. The sliding pin 321 of the electric-powered gear 320 can be inserted into the sliding groove 410, and when the electric-powered gear 320 rotates, the sliding pin 321 can slide along the sliding groove 410, causing the hinge arm 400 to move along a longitudinal direction.

In other words, a hinge structure for a coach door according to an embodiment of the present disclosure can rotate the first driving gear 220 through the rotation of the output shaft 211 of the motor 210, thereby rotating the electric-powered gear 320. By the rotation of the electric-powered gear 320, the sliding pin 321 can slide along the sliding groove 410, causing the hinge arm 400 to move linearly, thereby linearly moving the rear door.

Specifically, referring together to the contents illustrated in FIG. 2 and FIG. 5, the electric-powered plate 310 can include a main body 312, a curved portion 313, and an extension portion 315. Specifically, the second through-hole 311 can be formed in a lower portion of the main body 312. The curved portion 313 can be connected to the main body 312 and can be curved in the direction of the electric-powered gear 320. A strip-shaped hole 314 can be formed in the curved portion 313. The extension portion 315 can be extended from the curved portion 313 in a direction away from the main body 312, and a guide bump 316 for guiding the hinge arm 400 can be provided on a back surface of the extension portion 315. The other end portion of the hinge arm 400 can passe through the strip-shaped hole 314 and can be positioned between the guide bumps 316. The other end portion of the hinge arm 400 can pass through the strip-shaped hole 314 and can be positioned between the guide bumps 316, so that the hinge arm 400 may move linearly in a more stable manner.

As shown in FIG. 5, a shaft hole 323 can be formed in the center of the electric-powered gear 320. A shaft 317, which can be inserted into the shaft hole 323, can be fixed to the upper portion of the main body 312. A bushing 318 and a sleeve 319 can be installed on the shaft 317, the bushing 318 can be positioned between the inner wall of the shaft hole 323 and the outer wall of the shaft 317, and can be used to reduce friction between the electric-powered gear 320 and the shaft 317. The sleeve 319 can be positioned between the electric-powered gear 320 and the electric-powered plate 310, and can be used to maintain the position of the electric-powered gear 320 and the electric-powered plate 310. Similarly, a bushing may be installed between the first through-hole 111 and the second through-hole 311 and the output shaft 211 of the motor 210 to reduce friction.

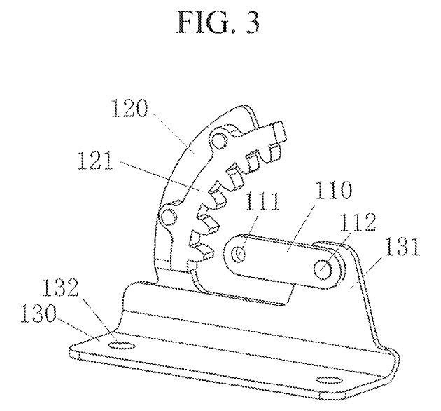

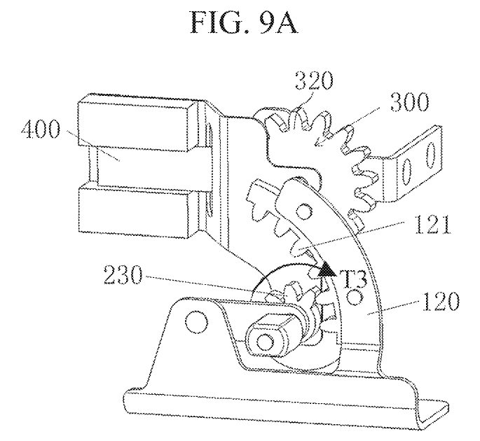

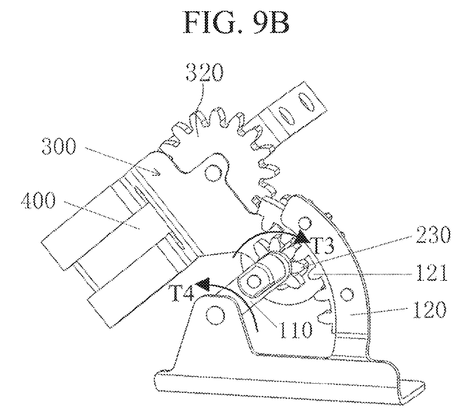

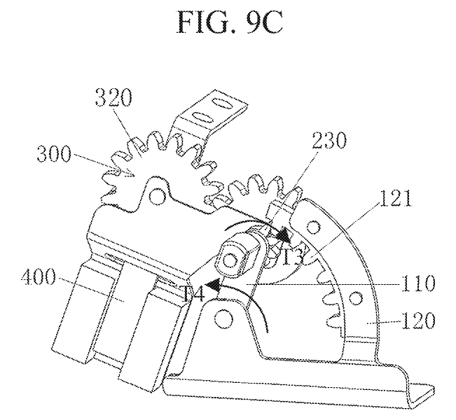

According to an embodiment of the present disclosure, as shown in FIG. 9A to FIG. 9C, the second driving gear 230 can roll along the guide arm 120 to move the driving assembly 200 along the guide arm 120. Specifically, as shown in FIG. 3, the guide arm 120 can be provided with guide teeth 121. The second driving gear 230 may engage with the guide teeth 121 and roll along the guide arm 120.

In other words, a hinge structure for a coach door according to an embodiment of the present disclosure can rotate the second driving gear 230 by the rotation of the output shaft 211 of the motor 210, causing the second driving gear 230 to roll along the guide arm 120. By the rolling of the second driving gear 230 along the guide arm 120, the connecting plate 110 hinged to the protruding plate 131 can rotate about the hinge shaft 112. Accordingly, by the rotation of the connecting plate 110, the driving assembly 200 may move along the guide arm 120. The movement of the driving assembly 200 along the guide arm 120 may move the hinge arm 400 in an arc shape to rotate the door.

In an embodiment, when the first driving gear 220 and the electric-powered gear 320 are engaged, the second driving gear 230 is not engaged with the guide teeth 121 (refer to FIG. 8B). In other words, in an embodiment, when the hinge arm 400 moves linearly, the hinge arm 400 does not move in an arc shape. In an embodiment, when the first driving gear 220 rotates by a first predetermined angle (corresponding to the first predetermined arc region), the first driving gear 220 no longer engages with the electric-powered gear 320 (refer to FIG. 8C), and the second driving gear 230 begins to engage with the guide teeth 121. That is, in an embodiment, after the hinge arm 400 has completely moved linearly, the hinge arm 400 begins to move in an arc shape. In an embodiment, when the second driving gear 230 rolls to the upper end portion of the guide arm 120, the second driving gear 230 no longer engages with the guide teeth 121, and in this case, the arc displacement of the hinge arm 400 is at a maximum, and the door rotates to a maximum open angle.

Another embodiment of the present disclosure provides a vehicle including the hinge structure for the coach door (e.g., as described above and shown in FIGS. 1-9C).

FIG. 8A to FIG. 8C are schematic views illustrating an operation process of a hinge structure for a coach door according to an embodiment of the present disclosure when an electric assembly performs a first operation. FIG. 9A to FIG. 9C are schematic views illustrating an operation process of a hinge structure for a coach door according to an embodiment of the present disclosure when an electric assembly performs a second operation.

Hereinafter, an operational process of a hinge structure for a coach door according to an embodiment of the present disclosure will be described with reference to the drawings.

In a typical case, a rear door of a vehicle is in a closed state, and the hinge structure for the coach door according to an embodiment of the present disclosure is in an initial state (see FIG. 8A). In this initial state (FIG. 8A), the output shaft 211 of the motor 210 has not started to rotate, and the first driving gear 220 starts to engage with the electric-powered gear 320. Also in this initial state (FIG. 8A), the sliding pin 321 is positioned at a position close to an upper portion of the electric-powered gear 320 in FIG. 8A and at a position close to an upper portion of the sliding groove 410 in FIG. 8A, the hinge arm 400 is in a forward position, and a portion of a structure of the rear door overlaps with a front door.

When a passenger in a rear seat needs to get in or out of the vehicle, the passenger operates the motor 210 through a button provided corresponding to the motor 210, and accordingly, the output shaft 211 of the motor 210 starts to rotate. Referring to FIG. 8A, due to the rotation of the output shaft 211, the first driving gear 220 rotates in a first rotational direction (T1), and as the first driving gear 220 starts to engage with the electric-powered gear 320, the electric-powered gear 320 rotates in a second rotational direction (T2). Due to the rotation of the electric-powered gear 320, the sliding pin 321 slides downward (in a downward direction in FIG. 8A) along the sliding groove 410, and the hinge arm 400 linearly moves rearward, so that the rear door of the vehicle linearly moves rearward. Referring to FIG. 8C, after the first driving gear 220 rotates by a first predetermined angle (corresponding to the first predetermined arc region) along the first rotational direction (T1), the first driving gear 220 no longer engages with the electric-powered gear 320. At this stage (FIG. 8C), the sliding pin 321 slides downward along the sliding groove 410 to a middle portion of the sliding groove 410, the hinge arm 400 moves rearward to a maximum extent, the rear door of the vehicle moves rearward to a farthest extent, and accordingly, the front door and the rear door are staggered in a non-overlapping state. In this process, the second driving gear 230 rotates along a third rotational direction (T3), but does not engage with the guide teeth 121 (see FIG. 8B), so the hinge arm 400 does not move in an arched shape.

Thereafter, referring to FIG. 9A to FIG. 9C, due to the continuous rotation of the output shaft 211, the second driving gear 230 starts to engage with the guide teeth 121, and the second driving gear 230 rolls upward (in an upward direction in FIG. 9A) along the guide arm 120 (see, e.g., FIG. 9B). Due to the rolling of the second driving gear 230 along the guide arm 120, the connecting plate 110 rotates in a fourth rotational direction (T4) around the hinge shaft 112, and the driving assembly 200 moves upward (in the upward direction in FIG. 9B) along the guide arm 120 by the rotation of the connecting plate 110. Due to the movement of the driving assembly 200 along the guide arm 120, the hinge arm 400 moves in an arched shape in a door opening direction, and accordingly, the rear door rotates in the door opening direction. When the second driving gear 230 rolls to an upper end portion of the guide arm 120, the second driving gear 230 no longer engages with the guide teeth 121 (see, e.g., FIG. 9C). At this stage (FIG. 9C), the hinge arm 400 has moved to a maximum extent in the arched shape, and the door rotates to a maximum opening angle, so it is convenient for the passenger in the rear seat to get in or out.

When the rear door of the vehicle needs to be closed, in contrast to the above process, the passenger operates the motor 210 through the button provided corresponding to the motor 210, thereby causing the output shaft 211 of the motor 210 to rotate, so that the second driving gear 230 starts to rotate in a fifth rotational direction (a direction opposite to the third rotational direction (T3)). Correspondingly, the second driving gear 230 rolls downward (in a downward direction in FIG. 9B) along the guide arm 120. Due to the rolling along the guide arm 120, the connecting plate 110 of the second driving gear 230 rotates in a sixth rotational direction (a direction opposite to the fourth rotational direction (T4)) around the hinge shaft 112, so that the driving assembly 200 moves downward (in the downward direction in FIG. 9B) along the guide arm 120 by the rotation of the connecting plate 110. Due to the movement of the driving assembly 200 along the guide arm 120, the hinge arm 400 moves in an arched shape in a door closing direction, and the rear door rotates in the door closing direction. When the second driving gear 230 rotates by a second predetermined angle (corresponding to the second predetermined arc region) along the fifth rotational direction, the second driving gear 230 no longer engages with the electric-powered gear 320 (see, e.g., FIG. 9A). At this stage (FIG. 9A), the rear door rotates to a maximum angle in the door closing direction.

Thereafter, due to the continuous rotation of the output shaft 211, the first driving gear 220 starts to engage with the electric-powered gear 320 and rotates in a seventh rotational direction (a direction opposite to the first rotational direction (T1)) (see, e.g., FIG. 8C), thereby causing the electric-powered gear 320 to rotate in an eighth rotational direction (a direction opposite to the second rotational direction (T2)). Due to the rotation of the electric-powered gear 320, the sliding pin 321 slides upward (in the upward direction in FIG. 8A) along the sliding groove 410, and the hinge arm 400 linearly moves forward, so that the rear door linearly moves forward. After the first driving gear 220 rotates by the first predetermined angle in the seventh rotational direction, the hinge arm 400 moves to the forward position, and a portion of the structure of the rear door overlaps with the front door. Accordingly, the hinge structure for the coach door according to the embodiment of the present disclosure is restored to the initial state (FIG. 8A), and the rear door is restored to the closed state.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the example embodiments with reference to the positions of such features as displayed in the figures. It can be further understood that the term “connect” or its derivatives can refer both to direct and indirect connection.

While the present disclosure has been described in connection with what is presently considered to be practical example embodiments, it can be understood that the present disclosure is not necessarily limited to the disclosed example embodiments. On the contrary, the present disclosure is intended to cover various modifications and equivalent arrangements included within the spirit and scopes of the appended claims.

What is claimed is:

1. A hinge structure for a vehicle coach door, comprising:
a connecting plate;
a fixed bracket configured to be fixed to a vehicle body, wherein a first end portion of the fixed bracket is hingedly coupled to the connecting plate, and a second end portion of the fixed bracket includes an arch-shaped guide arm;
a driving assembly coupled to the connecting plate to be movable along the guide arm;
an electric-powered assembly coupled to the driving assembly, wherein the electric-powered assembly and the driving assembly are configured to perform a first operation and a second operation; and
a hinge arm configured to be fixed to the vehicle coach door, wherein the hinge arm is coupled to the electric-powered assembly so as to be movable relative to the electric-powered assembly,
wherein the hinge arm is configured to be move linearly by the electric-powered assembly and the driving assembly relative to the electric-powered assembly during the first operation, and
wherein the hinge arm is configured to pivot in an arch shape relative to the fixed bracket by the driving assembly during the second operation.

2. The hinge structure of claim 1, wherein the connecting plate includes a first through hole and wherein the driving assembly comprises:
a motor including an output shaft, wherein the output shaft extends through the first through hole in the connecting plate,
a first driving gear including first teeth in a first arc region, wherein the first driving gear is fixed to the output shaft, and
a second driving gear including second teeth in a second arc region, wherein the second driving gear is fixed to the output shaft, and wherein the second driving gear is configured to roll along the guide arm to move the driving assembly along the guide arm during the second operation.

3. The hinge structure of claim 2, wherein the electric-powered assembly comprises:
an electric-powered plate having a second through hole in a lower portion of the electric-powered plate, wherein the second through hole is positioned between the first driving gear and the second driving gear, wherein the output shaft extends through the second through hole;
an electric-powered gear rotatably coupled on the electric-powered plate and engageable with the first driving gear; and
a sliding pin extending from the electric-powered gear at a sliding-pin position adjacent an edge of the electric-powered gear.

4. The hinge structure of claim 3, wherein a first hinge-arm end portion of the hinge arm is configured to be fixed to the vehicle coach door,
wherein the hinge arm includes a sliding groove extended along a width direction of the hinge arm at a central-region portion of the hinge arm, and wherein the sliding pin is inserted into the sliding groove, and wherein the sliding pin and sliding groove are configured such that the sliding pin slides along the sliding groove to cause the hinge arm to move along a length direction of the hinge arm based on rotation of the electric-powered gear.

5. The hinge structure of claim 4, wherein the guide arm includes guide teeth on the guide arm, and wherein the second driving gear is engageable with the guide teeth.

6. The hinge structure of claim 5, wherein the hinge structure is configured such that the second driving gear is not engaged with the guide teeth when the first driving gear and the electric-powered gear are engaged during the first operation, and
wherein the hinge structure is configured such that the first driving gear is not engaged with the electric-powered gear and the second driving gear begins to engage with the guide teeth based on the first driving gear being rotated by a first angle at a beginning of the second operation.

7. The hinge structure of claim 5, wherein the electric-powered plate comprises:
a main body;
a curved portion connected to the main body and curved in a first direction toward the electric-powered gear, wherein the curved portion includes a strip-shaped through hole in the curved portion, and wherein a second hinge-arm end portion of the hinge arm extends through the strip-shaped through hole;
an extension portion extending from the curved portion in a second direction away from the main body;
a pair of guide bumps on a back surface of the extension portion, wherein the pair of guide bumps are configured to linearly-slidably receive the second hinge-arm end portion of the hinge arm between the pair of guide bumps adjacent the strip-shaped through hole .

8. The hinge structure of claim 7, wherein the electric-powered gear includes
a shaft hole in a center of the electric-powered gear, and
further comprising a gear shaft inserted into the shaft hole, wherein the gear shaft is fixed to an upper portion of the main body.

9. The hinge structure of claim 8, further comprising:
a bushing on the gear shaft, wherein the bushing is positioned between an inner wall of the shaft hole and an outer wall of the gear shaft; and
a sleeve on the gear shaft, wherein the sleeve is positioned between the electric-powered gear and the electric-powered plate.

10. The hinge structure of claim 8, wherein the fixed bracket comprises:
a base plate; and
a protruding plate extending from a first base-plate end portion of the base plate, wherein the connecting plate is hingedly coupled to the protruding plate, and
wherein the guide arm is extending from a second base-plate end portion of the base plate and the guide arm is curved with a concave shape facing the connecting plate.

11. A vehicle comprising:
a vehicle body;
a coach door; and
a hinge structure comprising:
a connecting plate,
a fixed bracket coupled to the vehicle body, wherein a first end portion of the fixed bracket is hingedly coupled to the connecting plate, and a second end portion of the fixed bracket includes an arch-shaped guide arm,
a driving assembly coupled to the connecting plate to be movable along the guide arm,
an electric-powered assembly coupled to the driving assembly, wherein the electric-powered assembly and the driving assembly are configured to perform a first linear-movement operation and a second arc-movement operation, and
a hinge arm coupled to the coach door, wherein the hinge arm is coupled to the electric-powered assembly so as to be movable relative to the electric-powered assembly,
wherein the hinge arm is configured to be move linearly by the electric-powered assembly and the driving assembly relative to the electric-powered assembly during the first linear-movement operation, and
wherein the hinge arm is configured to pivot in an arch shape relative to the fixed bracket by the driving assembly during the second arc-movement operation.

12. The vehicle of claim 11, wherein the connecting plate includes a first through hole and wherein the driving assembly comprises:
a motor including an output shaft, wherein the output shaft extends through the first through hole in the connecting plate,
a first driving gear including first teeth in a first arc region, wherein the first driving gear is fixed to the output shaft, and
a second driving gear including second teeth in a second arc region, wherein the second driving gear is fixed to the output shaft, and wherein the second driving gear is configured to roll along the guide arm to move the driving assembly along the guide arm during the second arc-movement operation.

13. The vehicle of claim 12, wherein the electric-powered assembly comprises:
an electric-powered plate having a second through hole in a lower portion of the electric-powered plate, wherein the second through hole is positioned between the first driving gear and the second driving gear, wherein the output shaft extends through the second through hole;
an electric-powered gear rotatably coupled on the electric-powered plate and engageable with the first driving gear; and
a sliding pin extending from the electric-powered gear at a sliding-pin position adjacent an edge of the electric-powered gear.

14. The vehicle of claim 13, wherein a first hinge-arm end portion of the hinge arm is fixed to the coach door,
wherein the hinge arm includes a sliding groove extended along a width direction of the hinge arm at a central portion of the hinge arm, and
wherein the sliding pin is inserted into the sliding groove, and wherein the sliding pin and sliding groove are configured such that the sliding pin slides along the sliding groove to cause the hinge arm to move along a length direction of the hinge arm based on rotation of the electric-powered gear.

15. The vehicle of claim 14, wherein the guide arm includes guide teeth on the guide arm, and wherein the second driving gear is engageable with the guide teeth.

16. The vehicle of claim 15, wherein the hinge structure is configured such that the second driving gear is not engaged with the guide teeth when the first driving gear and the electric-powered gear are engaged during the first linear-movement operation, and
wherein the hinge structure is configured such that the first driving gear is not engaged with the electric-powered gear and the second driving gear begins to engage with the guide teeth based on the first driving gear being rotated by a first angle at a beginning of the second arc-movement operation.

17. The vehicle of claim 16, wherein the electric-powered plate comprises:
a main body;
a curved portion connected to the main body and curved in a first direction toward the electric-powered gear, wherein the curved portion includes a strip-shaped through hole in the curved portion, and wherein a second hinge-arm end portion of the hinge arm extends through the strip-shaped through hole;
an extension portion extending from the curved portion in a second direction away from the main body;
a pair of guide bumps on a back surface of the extension portion, wherein the pair of guide bumps are configured to linearly-slidably receive the second hinge-arm end portion of the hinge arm between the pair of guide bumps adjacent the strip-shaped through hole.

18. The vehicle of claim 17, wherein the electric-powered gear includes a shaft hole in a center of the electric-powered gear, and wherein the vehicle further comprises:
a gear shaft inserted into the shaft hole, wherein the gear shaft is fixed to an upper portion of the main body;
a bushing on the gear shaft, wherein the bushing is positioned between an inner wall of the shaft hole and an outer wall of the gear shaft; and
a sleeve on the gear shaft, wherein the sleeve is positioned between the electric-powered gear and the electric-powered plate.

19. The hinge structure of claim 18, wherein the fixed bracket comprises:
a base plate; and
a protruding plate extending from a first base-plate end portion of the base plate, wherein the connecting plate is hingedly coupled to the protruding plate, and wherein the guide arm is extending from a second base-plate end portion of the base plate and the guide arm is curved with a concave shape facing the connecting plate.

20. A method of opening a coach door of a vehicle, comprising:
rotating a motor shaft with an electric motor;
rotating a first gear with the motor shaft based on the rotating of the motor shaft, wherein the first gear includes first gear teeth along only a first-gear arc portion of the first gear;
rotating a second gear based on the rotating of the first gear, wherein the second gear includes second gear teeth engageable with the first gear teeth of the first gear, and wherein the second gear includes a slider pin extending from the second gear at a location adjacent an edge of the second gear;
translating the rotating of the second gear to linearly moving a hinge arm via a slider slot in the hinge arm, wherein the slider pin is in the slider slot, and wherein the hinge arm is coupled to the coach door;
linearly moving the coach door based on the linearly moving of the hinge arm;
continuing the rotating of the motor shaft and rotating a third gear based on continuing the rotating of the motor shaft, wherein the third gear and the first gear are fixed on the motor shaft to rotate together, and wherein the third gear includes third gear teeth along on only a third-gear arc portion of the third gear;
disengaging the first gear teeth from the second gear teeth and engaging the third gear teeth with guide teeth on an arc-shaped guide arm, based on continuing the rotating of the motor shaft and based on the rotating of the third gear;
pivoting the hinge arm about a rotation axis based on the rotating of the third gear and based on the engaging of the third gear teeth with the guide teeth;
pivoting the coach door based on the pivoting of the hinge arm; and
opening the coach door based on the pivoting of the coach door.
